(19) United States
(12) Patent Application Publication
(10) Pub. No.: US 2011/0092170 A1
(43) Pub. Date: Apr. 21, 2011

(54) PORTABLE ELECTRONIC COMMUNICATIONS APPARATUS, COMMUNICATIONS SYSTEM, METHOD OF PURGING ERROR DATA THEREFOR AND METHOD OF REDUCING RE-TUNING DELAY THEREFOR

(76) Inventor: Theo Kamalski, Weert (NL)

(21) Appl. No.: 12/736,745

(22) PCT Filed: May 29, 2008
(86) PCT No.: PCT/EP2008/004612

§ 371 Date: Nov. 19, 2010

(51) Int. Cl. H04B 1/40

(52) U.S. Cl. 455/77

(57) ABSTRACT

A portable electronic communications apparatus includes a processing resource operably coupled to a Radio Data System communications unit. In at least one embodiment, the processing resource is also arranged to identify, when in use, a number of available frequencies capable of serving as a number of Alternative Frequencies, respectively. The processing resource communicates on a tuned frequency first Radio Data System data identifying the number of Alternative Frequencies. A data store is also operably coupled to the processing resource. The Radio Data System communications unit is arranged to re-tune, when in use, from the tuned frequency to another frequency of the number of available frequencies and to communicate on the another frequency second Radio Data System data, the re-tuning being supplemental to any re-tuning initiated as a result of inadequate signal strength associated with the tuned frequency. The number of Alternative Frequencies is kept below a certain maximum. The apparatus can be a navigation system.

### FIELD OF THE INVENTION

The present invention relates to a portable electronic communications apparatus of the type that, for example, is capable of generating Radio Data System data identifying Alternative Frequencies. The present invention also relates to a method of purging error data from a memory of a receiver, the method being of the type that communicates Radio Data System data identifying Alternative Frequencies. The present invention further relates to a method of reducing a re-tuning delay caused by error data in a memory of a receiver, the method being of the type that communicates Radio Data System data identifying Alternative Frequencies. The present invention also relates to a communications system of the type that, for example, is capable of generating Radio Data System data identifying Alternative Frequencies.

### BACKGROUND TO THE INVENTION

Portable computing devices, for example Portable Navigation Devices (PNDs) that include GPS (Global Positioning System) signal reception and processing functionality are well known and are widely employed as in-car or other vehicle navigation systems.

In general terms, a modern PND comprises a processor, memory (at least one of volatile and non-volatile, and commonly both), and map data stored within said memory. The processor and memory cooperate to provide an execution environment in which a software operating system may be established, and additionally it is commonplace for one or more additional software programs to be provided to enable the functionality of the PND to be controlled, and to provide various other functions.

Typically these devices further comprise one or more input interfaces that allow a user to interact with and control the device, and one or more output interfaces by means of which information may be relayed to the user. Illustrative examples of output interfaces include a visual display and a speaker for audible output. Illustrative examples of input interfaces include one or more physical buttons to control on/off operation or other features of the device (which buttons need not necessarily be on the device itself but could be on a steering wheel if the device is built into a vehicle), and a microphone for detecting user speech. In one particular arrangement, the output interface display may be configured as a touch sensitive display (by means of a touch sensitive overlay or otherwise) additionally to provide an input interface by means of which a user can operate the device by touch.

Devices of this type will also often include one or more physical connector interfaces by means of which power and optionally data signals can be transmitted to and received from the device, and optionally one or more wireless transmitters/receivers to allow communication over cellular telecommunications and other signal and data networks, for example Bluetooth, Wi-Fi, Wi-Max, GSM, UMTS and the like.

PNDs of this type also include a GPS antenna by means of which satellite-broadcast signals, including location data, can be received and subsequently processed to determine a current location of the device.

The PND may also include electronic gyroscopes and accelerometers which produce signals that can be processed to determine the current angular and linear acceleration, and in turn, and in conjunction with location information derived from the GPS signal, velocity and relative displacement of the device and thus the vehicle in which it is mounted. Typically, such features are most commonly provided in in-vehicle navigation systems, but may also be provided in PNDs if it is expedient to do so.

The utility of such PNDs is manifested primarily in their ability to determine a route between a first location (typically a start or current location) and a second location (typically a destination). These locations can be input by a user of the device, by any of a wide variety of different methods, for example by postcode, street name and house number, previously stored “well known” destinations (such as famous locations, municipal locations (such as sports grounds or swimming baths) or other points of interest), and favourite or recently visited destinations.

Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice (for example the driver may specify that the route should not include motorways or toll roads).

In addition, the device may continually monitor road and traffic conditions, and offer to or choose to change the route over which the remainder of the journey is to be made due to changed conditions. Real time traffic monitoring systems, based on various technologies (e.g. mobile phone data exchanges, fixed cameras, GPS fleet tracking) are being used to identify traffic delays and to feed the information into notification systems.

PNDs of this type may typically be mounted on the dashboard or windscreen of a vehicle, but may also be formed as part of an on-board computer of the vehicle radio or indeed as part of the control system of the vehicle itself. The navigation device may also be part of a hand-held system, such as a PDA (Portable Digital Assistant), a media player, a mobile phone or the like, and in these cases, the normal functionality of the hand-held system is extended by means of the installation of software on the device to perform both route calculation and navigation along a calculated route.

Route planning and navigation functionality may also be provided by a desktop or mobile computing resource running appropriate software. For example, the Royal Automobile Club (RAC) provides an on-line route planning and navigation facility at http://www.rac.co.uk, which facility allows a user to enter a start point and a destination whereupon the server with which the user's computing resource is communicating calculates a route (aspects of which may be user specified), generates a map, and generates a set of exhaustive navigation instructions for guiding the user from the selected start point to the selected destination. The facility also provides for pseudo three-dimensional rendering of a calculated route, and route preview functionality which simulates a user travelling along the route and thereby provides the user with a preview of the calculated route.

In the context of a PND, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function, and navigation along such a route is another primary function.

During navigation along a calculated route, it is usual for such PNDs to provide visual and/or audible instructions to guide the user along a chosen route to the end of that route, i.e. the desired destination. It is also usual for PNDs to display map information on-screen during the navigation, such information regularly being updated on-screen so that the map information displayed is representative of the current location of the device, and thus of the user or user's vehicle if the device is being used for in-vehicle navigation.

An icon displayed on-screen typically denotes the current device location, and is centred with the map information of current and surrounding roads in the vicinity of the current device location and other map features also being displayed. Additionally, navigation information may be displayed, optionally in a status bar above, below or to one side of the displayed map information, examples of navigation information include a distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that: a user deviates from the previously calculated route during navigation (either by accident or intentionally); real-time traffic conditions dictate that an alternative route would be more expedient and the device is suitably enabled to recognize such conditions automatically, or if a user actively causes the device to perform route re-calculation for any reason.

It is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POIs) tagged as being for example of scenic beauty, or, using stored information indicative of prevailing traffic conditions on particular roads, order the calculated routes in terms of a level of likely congestion or delay on account thereof. Other POI-based and traffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

Devices of the type described above, for example the 720T model manufactured and supplied by TomTom International B.V., provide a reliable means for enabling users to navigate from one position to another. Such devices are of great utility when the user is not familiar with the route to the destination to which they are navigating.

In order to facilitate in-vehicle use of the PND, some PNDs are equipped with a Frequency Modulation (FM) transmitter, for example the 920T model PND available from TomTom International B.V. Instead of amplified audio signals being reproduced by a loudspeaker of the PND, the FM transmitter frequency modulates and transmits the audio signals on a user-selectable frequency. When in a vehicle, a user of the PND tunes an FM radio located in the vehicle to the user-selected frequency so that the FM radio receives the frequency modulated audio signal, demodulates the frequency modulated audio signal and reproduces the audio signal through loudspeakers coupled to the FM radio. Of course, the FM radio can be part of an in-vehicle entertainment system capable of FM reception and including a Compact Disc (CD) multi-changer and other facilities.

It should be noted that it is desirable to use the loudspeakers of in-vehicle entertainment systems via FM transmission for other types of portable device, for example so-called MP3 players and/or mobile telephones. Indeed, it is known for such other portable devices to possess so-called Short-Range Radio (SRR) FM transmitters to transmit audio to FM receivers.

More recently, it has been discovered that advantage can be taken of Radio Data System (RDS) capabilities possessed by many in-vehicle entertainment systems, for example RDS FM radios. On an available channel, a portable device equipped with an RDS encoder transmits, inter alia, a Programme Identification (PI) code, a Programme Service (PS) name (for example, “TomTom”) and a list of Alternative Frequencies (AFs), the available channel and the list of AFs being selected from free channels detected amongst an FM “landscape” of channels in which the portable device is operating. The portable device also typically transmits an audio test message on the same available channel. The formation and transmission of the PI code, the PS name and the list of AFs are in accordance with the RDS technical specification set out by the International Electrotechnical Commission (IEC).

AFs are usually used by broadcasters to identify their respective broadcast networks. A transmitted list of AFs indicates frequencies of adjacent transmitters associated with a same radio programme as a transmitter currently being received. FM radios in vehicles use the list of AFs to select and remain tuned to a transmitter with a best signal strength associated with the same network. The FM radios store the list of AFs received from the transmitter and update the list of AFs each time the FM radios tune to a different transmitter in the network. However, in the context of SRR transmitters, the AF feature can be used by the PND to enable use of different frequencies so as to avoid interference.

In the vehicle, for example, the user sets the FM radio to scan for an FM transmission from the portable device and identified by the RDS information transmitted by the portable device. When the transmission by the portable device has been found by the FM radio, the frequency modulated audio signal transmitted by the portable device, typically the audio test message, is reproduced by the loudspeakers of the FM radio and a display of the FM radio displays the PS name, namely “TomTom” in this example.

The transmission of RDS data is, as in relation to other forms of wireless data transmissions, susceptible to errors as a result of external influences, for example so-called multi-path effects. In respect of a moving receiver, multi-path effects are caused by reflections of a transmitted signal by, for example buildings, mountains and/or bodies of water. In order to detect errors, the RDS employs so-called cyclic redundancy checking, whereby data blocks transmitted each comprise a 16 bit information word and a 10 bit checkword. The checkword is formed according to a predetermined algorithm and enables the moving receiver to detect certain types of errors, if present, in the information word of an associated data block. However, the ability to detect errors in received data blocks as a result of the use of a Cyclic Redundancy Check (CRC) checkword is not without bound and it is possible for certain types of error in the 16 bit information words to go undetected by the receiver. Such errors are known as “Non-Recognisable Errors” (NREs). To some extent, the number of NREs that can occur in a received data block depends upon, in addition to multi-path effects, the quality of a given received signal transmitted and properties of an antenna of the receiver. A further known measure sometimes implemented is the provision of redundant information, for example by repetition of certain transmitted information, in order to avoid receipt of incorrect data as a result of NREs.

However, whilst the error detection and prevention measures mentioned above serve to minimise the effects of errors in a transmitter-receiver infrastructure intended by the RDS technical specification mentioned above, the occurrence of errors increases when SRR transmitters are employed and have the occurrence of NREs increases. One reason for increased error occurrence is the lower performance level of FM antennas used in portable electronic communications equipment as compared with an external antenna used by a transmitter of a local or national broadcaster. Other factors that influence signal reception are the size and shape of a windscreen or other windows of a vehicle, any coatings applied to the windscreen or windows and/or the presence of embedded wires within, or wires applied to a surface of, the windscreen or other windows in order to facilitate heating of the windscreen or other windows.

As a result of the increased occurrence of NREs, FM radios can store erroneous AFs in the memory of the FM radio. Unfortunately, the RDS technical specification does not provide a specific solution to address incorrect AFs stored in the memory of the FM radio of a vehicle. Furthermore, the memory of the FM radio does not update as frequently as in relation to non-SRR originating transmissions, because transmission from the SRR inherently assumes a single transmitter that accompanies the FM radio and so no need exists to re-tune to different transmitters broadcasting the same radio programme. The problem is ameliorated slightly during long journeys made by the vehicle, as the likelihood of interference being experienced, at a frequency to which the FM radio is tuned, is higher over the duration of the journey and so the list of AFs stored by the memory of the FM radio will be updated.

However, the problem is, in contrast, exacerbated by repeated short journeys made by the vehicle, because the FM radio typically does not re-tune to any of the AFs as an initial channel selected by the PND does not suffer degradation in quality over the short journey. Consequently, the memory of the FM radio does not get updated and simply fills with AF data transmitted by the PND and, as such, also fills with erroneous AFs occurring as a result of NREs.

Typically, RDS-capable FM radios store the AF data in the memory thereof as described above, but the memory is not limitless and a maximum storage capacity of 25 AFs is common. Consequently, depending upon actual implementation, the response of the FM radio to the memory reaching capacity can vary. In one implementation, the memory can be arranged as a First-In-First-Out (FIFO) buffer and a new entry in an AF list simply “pushes” an oldest AF entry off the AF list in the event that the memory capacity has been reached. In another implementation, the memory is fixed and once the capacity has been reached no further AF entries are added to the AF list.

Whilst one implementation may be less susceptible to retention of erroneous AFs than the other, the memory still stores an unacceptable number of erroneous AFs. The impact of the erroneous AFs on a listener to the FM radio is that the FM radio has to work through the list of AFs in the hope of finding a correct AF that can be used. The time taken to find the correct AF can be noticeable to the listener and can spoil the listening experience of the listener, especially when listening to recreational audio generated by a portable electronic device, for example a media player, such as a music player.

### SUMMARY OF THE INVENTION

According to a first aspect of the present invention, there is provided a portable electronic communications apparatus, comprising: a processing resource operably coupled to a Radio Data System communications unit, the processing resource being arranged to identify, when in use, a number of available frequencies capable of serving as a number of Alternative Frequencies, respectively, and to communicate on a tuned frequency first Radio Data System data identifying the number of Alternative Frequencies; and a data store operably coupled to the processing resource; wherein the Radio Data System communications unit is arranged to re-tune, when in use, from the tuned frequency to another frequency of the number of available frequencies and to communicate on the another frequency second Radio Data System data, the re-tuning being supplemental to any re-tuning initiated as a result of inadequate signal strength associated with the tuned frequency.

The data store may be arranged to store the number of Alternative Frequencies. The first Radio Data System data may comprise a number of messages, for example a number of groups.

The processing resource may be arranged to identify another number of available frequencies capable of serving as another number of Alternative Frequencies, respectively, and to communicate on the another frequency the second Radio Data System data; the second Radio Data System data may identify the another number of Alternative Frequencies.

The data store may be arranged to store the another number of Alternative Frequencies in place of the number of Alternative Frequencies.

The Radio Data System communications unit may be arranged to re-tune to the another frequency in accordance with a periodic update trigger scheme. The periodic update trigger scheme may comprise hourly re-tuning, bi-hourly re-tuning, daily re-tuning, weekly re-tuning and/or monthly re-tuning.

The Radio Data System communications unit may be arranged to re-tune to the another frequency in response to start-up of the Radio Data System communications unit.

The Radio Data System communications unit may be arranged to re-tune to the another frequency in accordance with a random update trigger scheme.

The processing resource may be arranged to select the number of Alternative Frequencies from a plurality of available frequencies capable of serving as a plurality of Alternative Frequencies, respectively, so as to be less than in quantity a total number of the plurality of Alternative Frequencies; the number of Alternative Frequencies communicated may constitute a cap in quantity of Alternative Frequencies with respect to the total number of the plurality of available frequencies.

The processing resource may be arranged to identify the plurality of Alternative Frequencies prior to selection therefrom.

The cap may be less than a predetermined maximum number of Alternative Frequencies associated with a Radio Data System technical specification or a Radio Broadcast Data System technical specification. The cap may be less than about 25 Alternative Frequencies, for example less than about 20 Alternative Frequencies, such as less than about 15 Alternative Frequencies. The cap may be even less than about 15 Alternative Frequencies, for example less than about 10 Alternative Frequencies, such as less than about 5 Alternative Frequencies.

According to a second aspect of the present invention, there is provided a portable navigation device comprising the portable electronic communications apparatus as set forth above in relation to the first aspect of the invention.

According to a third aspect of the present invention, there is provided a method of purging error data from a memory of a receiver, the method comprising: a portable electronic communications apparatus identifying a number of available frequencies capable of serving as a number of Alternative Frequencies, respectively; communicating on a tuned frequency first Radio Data System data identifying the number of Alternative Frequencies; re-tuning from the tuned frequency to another frequency of the number of available frequencies, the re-tuning being supplemental to any re-tuning initiated as a result of inadequate signal strength associated with the tuned frequency; and communicating on the another frequency second Radio Data System data.

According to a fourth aspect of the present invention, there is provided a portable electronic communications apparatus, comprising: a processing resource operably coupled to a Radio Data System communications unit, the processing resource being arranged to identify, when in use, a number of available frequencies capable of serving as a number of Alternative Frequencies, respectively, and to communicate on a tuned frequency first Radio Data System data identifying the number of Alternative Frequencies; and a data store operably coupled to the processing resource; wherein the processing resource is arranged to select, when in use, the number of Alternative Frequencies from a plurality of available frequencies capable of serving as a plurality of Alternative Frequencies, respectively, so as to be less than in quantity a total number of the plurality of Alternative Frequencies, the number of Alternative Frequencies communicated constituting a cap in quantity of Alternative Frequencies with respect to the total number of the plurality of available frequencies.

The cap may be less than a predetermined maximum number of Alternative Frequencies associated with a Radio Data System technical specification or a Radio Broadcast Data System technical specification. The cap may be less than about 25 Alternative Frequencies, for example less than about 20 Alternative Frequencies, such as less than about 15 Alternative Frequencies. The cap may be even less than about 15 Alternative Frequencies, for example less than about 10 Alternative Frequencies, such as less than about 5 Alternative Frequencies.

According to a fifth aspect of the present invention, there is provided a communications system, comprising: a portable electronic communications apparatus as set forth above in relation to the fourth aspect of the invention; and a receiver having a memory capacity capable of storing a maximum number of Alternative Frequencies; wherein the processing resource is arranged to implement the cap as less than the maximum number of Alternative frequencies.

The receiver may be an FM receiver. The cap may be less than the maximum number of Alternative frequencies by a predetermined margin. The predetermined margin may be at least 5 Alternative Frequencies.

According to a sixth aspect of the present invention, there is provided a method of reducing a re-tuning delay caused by error data in a memory of a receiver, the method comprising: a portable electronic communications apparatus identifying a number of available frequencies capable of serving as a number of Alternative Frequencies, respectively; selecting the number of Alternative Frequencies from a plurality of available frequencies capable of serving as a plurality of Alternative Frequencies, respectively, so as to be less than in quantity a total number of the plurality of Alternative Frequencies; and communicating on a tuned frequency first Radio Data System data identifying the number of Alternative Frequencies, the number of Alternative Frequencies communicated constituting a cap in quantity of Alternative Frequencies with respect to the total number of the plurality of available frequencies.

The method may further comprise: identifying the plurality of Alternative Frequencies prior to selection therefrom.

According to a seventh aspect of the present invention, there is provided a computer program element comprising computer program code means to make a computer execute the method as set forth above in relation to the third or sixth aspects of the invention.

The computer program element may be embodied on a computer readable medium.

It is thus possible to provide a portable electronic communications apparatus and a method of purging error data from a memory of a receiver that results in a lower probability of a receiver trying to use an Alternative Frequency that is erroneous as a result of an NRE. Furthermore, the memory of the receiver is prevented from collecting erroneous NREs to the point where the memory only comprises or nearly only comprises erroneous NREs. The reduced use of erroneous Alternative Frequencies results in fewer re-tuning delays by the receiver and hence an improved listening experience for a listener. Additionally, the need to manually re-tune the receiver is reduced, thereby reducing, for example, driver workload and hence improving safe use of the portable communications apparatus and/or the receiver. It is also possible to provide a portable electronic communications apparatus, a communication system and method of reducing a re-tuning delay caused by error data in a memory of a receiver that results in a lower probability of a receiver trying to use an Alternative Frequency that is erroneous as a result of an NRE. Furthermore, collection of erroneous NREs, by the memory of the receiver, to the point where the memory only comprises or nearly only comprises erroneous NREs, is minimised. The reduced use of erroneous Alternative Frequencies results in fewer re-tuning delays by the receiver and hence an improved listening experience for a listener. Additionally, the need to manually re-tune the receiver is reduced, thereby reducing, for example, driver workload and hence improving safe use of the portable communications apparatus and/or the receiver.

Other advantages of these embodiments are set out hereafter, and further details and features of each of these embodiments are defined in the accompanying dependent claims and elsewhere in the following detailed description.

### BRIEF DESCRIPTION OF THE DRAWINGS

At least one embodiment of the invention will now be described, by way of example only, with reference to the accompanying drawings, in which:

FIG. 1 is a schematic illustration of an exemplary part of a Global Positioning System (GPS) usable by a navigation device;

FIG. 2 is a schematic diagram of electronic components of a navigation device constituting an embodiment of the invention;

FIG. 3 is a schematic diagram of a part of FIG. 2 coupled to a communications unit;

FIG. 4 is a schematic representation of an architectural stack employed by the navigation device of FIG. 2;

FIG. 5 is a schematic diagram of the navigation device of FIG. 2 in a vehicle;

FIG. 6 is a schematic diagram of a docking arrangement for optional use in the vehicle of FIG. 5;

FIG. 7 is a flow diagram of a method of reducing a re-tuning delay using the navigation device of FIG. 2;

FIGS. 8 to 13 are screen shots from a display of a navigation device following the method of FIG. 7;

FIG. 14 is a flow diagram of a method of purging a memory of a receiver constituting another embodiment of the invention; and

FIG. 15 is a flow diagram of a response by the receiver to the method of FIG. 14.

### DETAILED DESCRIPTION OF PREFERRED EMBODIMENTS

Throughout the following description identical reference numerals will be used to identify like parts.

A number of embodiments of the present invention will now be described with particular reference to a PND. It should be remembered, however, that the teachings of the present invention are not limited to PNDs but are instead universally applicable to any type of processing device that is configured to execute navigation software in a portable manner so as to provide route planning and navigation functionality. It follows therefore that in the context of the present application, a navigation device is intended to include (without limitation) any type of route planning and navigation device, irrespective of whether that device is embodied as a PND, a vehicle such as an automobile, or indeed a portable computing resource, for example a portable personal computer (PC), a mobile telephone or a Personal Digital Assistant (PDA) executing route planning and navigation software. However, it should be appreciated that the embodiments described herein are also applicable to portable electronic devices that are not used to provide route planning and/or navigation functionality.

It will also be apparent from the following that the teachings of the present invention even have utility in circumstances, where a user is not seeking instructions on how to navigate from one location to another, but merely wishes to provide audio output to one or more nearby loudspeakers.

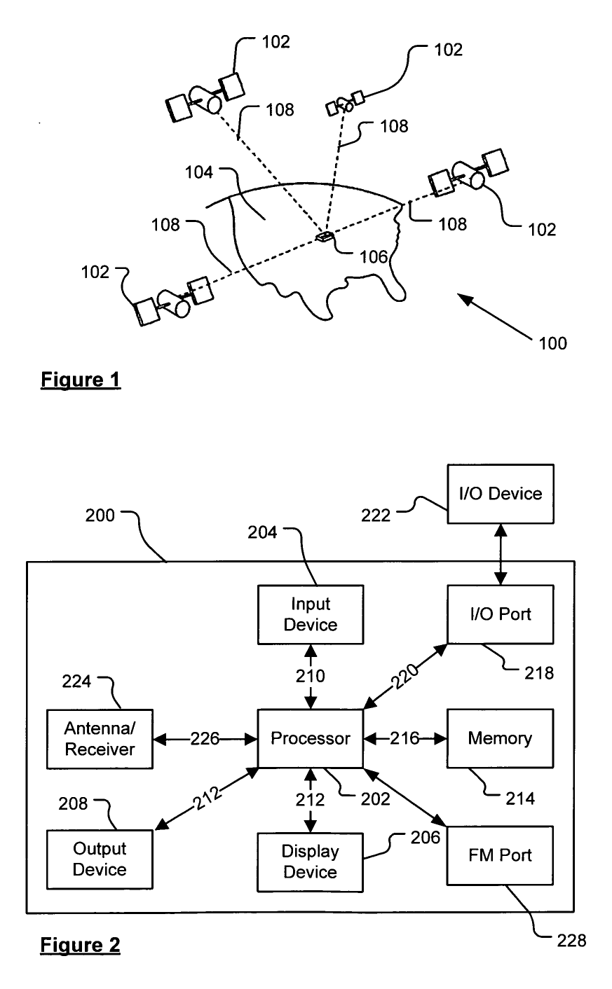

With the above provisos in mind, the Global Positioning System (GPS) of FIG. 1 and the like are used for a variety of purposes. In general, the GPS is a satellite-radio based navigation system capable of determining continuous position, velocity, time, and in some instances direction information for an unlimited number of users. Formerly known as NAVSTAR, the GPS incorporates a plurality of satellites which orbit the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal allows the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 102 are in orbit about the earth 104. The orbit of each satellite 102 is not necessarily synchronous with the orbits of other satellites 102 and, in fact, is likely to be asynchronous. A GPS receiver 106 is shown receiving spread spectrum GPS satellite signals 108 from the various satellites 102.

The spread spectrum signals 108, continuously transmitted from each satellite 102, utilize a highly accurate frequency standard accomplished with an extremely accurate atomic clock. Each satellite 102, as part of its data signal transmission 108, transmits a data stream indicative of that particular satellite 102. It is appreciated by those skilled in the relevant art that the GPS receiver device 106 generally acquires spread spectrum GPS satellite signals 108 from at least three satellites 102 for the GPS receiver device 106 to calculate its two-dimensional position by triangulation. Acquisition of an additional signal, resulting in signals 108 from a total of four satellites 102, permits the GPS receiver device 106 to calculate its three-dimensional position in a known manner.

Referring to FIG. 2, it should be noted that the block diagram of the navigation device 200 is not inclusive of all components of the navigation device, but is only representative of many example components. The navigation device 200 is located within a housing (not shown). The navigation device 200 includes a processing resource comprising, for example, a processor 202, the processor 202 being coupled to an input device 204 and a display device, for example a display screen 206. Although reference is made here to the input device 204 in the singular, the skilled person should appreciate that the input device 204 represents any number of input devices, including a keyboard device, voice input device, touch panel and/or any other known input device utilised to input information. Likewise, the display screen 206 can include any type of display screen such as a Liquid Crystal Display (LCD), for example.

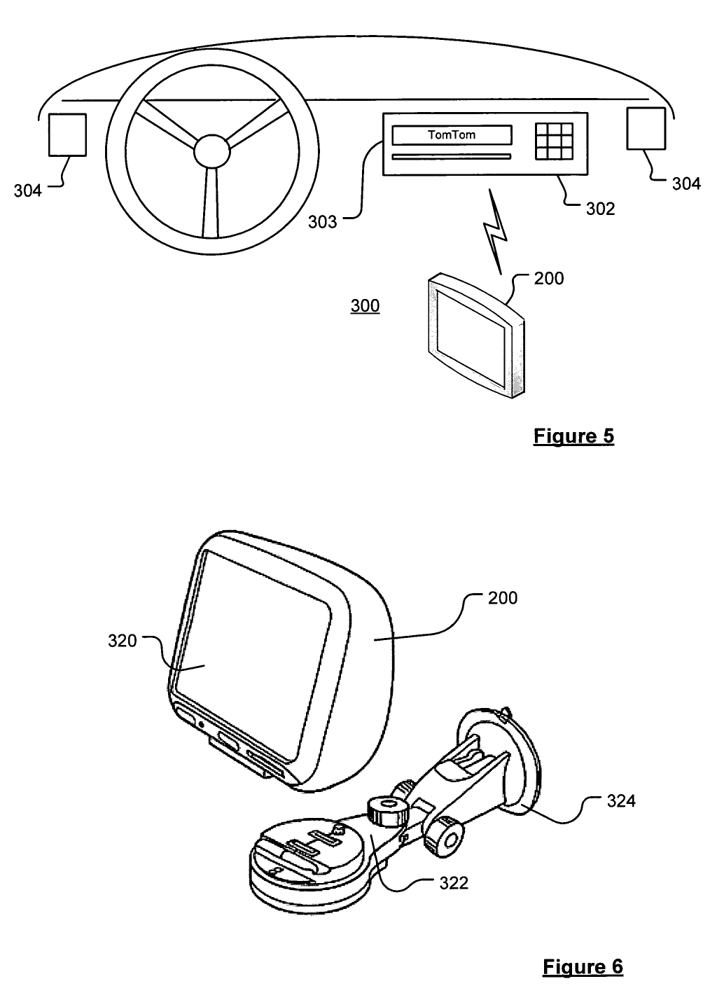

In one arrangement, one aspect of the input device 204, the touch panel, and the display screen 206 are integrated so as to provide an integrated input and display device, including a touchpad or touchscreen input 320 (FIG. 6) to enable both input of information (via direct input, menu selection, etc.) and display of information through a touch panel screen so that a user need only touch a portion of the display screen 320 to select one of a plurality of display choices or to activate one of a plurality of virtual or “soft” buttons. In this respect, the processor 202 supports a Graphical User Interface (GUI) that operates in conjunction with the touchscreen 320.

In the navigation device 200, the processor 202 is operatively connected to and set to receive input information from input device 204 via a connection 210, and operatively connected to at least one of the display screen 206 and the output device 208, via respective output connections 212, to output information thereto. The navigation device 200 may include an output device 208, for example an audible output device (e.g. a loudspeaker). As the output device 208 can produce audible information for a user of the navigation device 200, it is should equally be understood that input device 204 can include a microphone and software for receiving input voice commands as well. Further, the navigation device 200 can also include any additional input device 204 and/or any additional output device, such as audio input/output devices for example.

The processor 202 is operatively connected to memory 214, constituting a data store, via connection 216 and is further adapted to receive/send information from/to input/output (I/O) ports 218 via connection 220, wherein the I/O port 218 is connectable to an I/O device 222 external to the navigation device 200. The external I/O device 222 may include, but is not limited to an external listening device, such as an earpiece for example. The connection to I/O device 222 can further be a wired or wireless connection to any other external device such as a car stereo unit for hands-free operation and/or for voice activated operation for example, for connection to an earpiece or headphones, and/or for connection to a mobile telephone for example, wherein the mobile telephone connection can be used to establish a data connection between the navigation device 200 and the Internet or any other network for example, and/or to establish a connection to a server via the internet or some other network for example.

FIG. 2 further illustrates an operative connection between the processor 202 and an antenna/receiver 224 via connection 226, wherein the antenna/receiver 224 can be a GPS antenna/receiver for example. It will be understood that the antenna and receiver designated by reference numeral 224 are combined schematically for illustration, but that the antenna and receiver may be separately located components, and that the antenna may be a GPS patch antenna or helical antenna for example.

In order to support the functionality described herein, the processor 202 is also coupled to a Frequency Modulation (FM) port 228.

It will, of course, be understood by one of ordinary skill in the art that the electronic components shown in FIG. 2 are powered by one or more power sources (not shown) in a conventional manner. As will be understood by one of ordinary skill in the art, different configurations of the components shown in FIG. 2 are contemplated. For example, the components shown in FIG. 2 may be in communication with one another via wired and/or wireless connections and the like. Thus, the navigation device 200 described herein can be a portable or handheld navigation device 200.

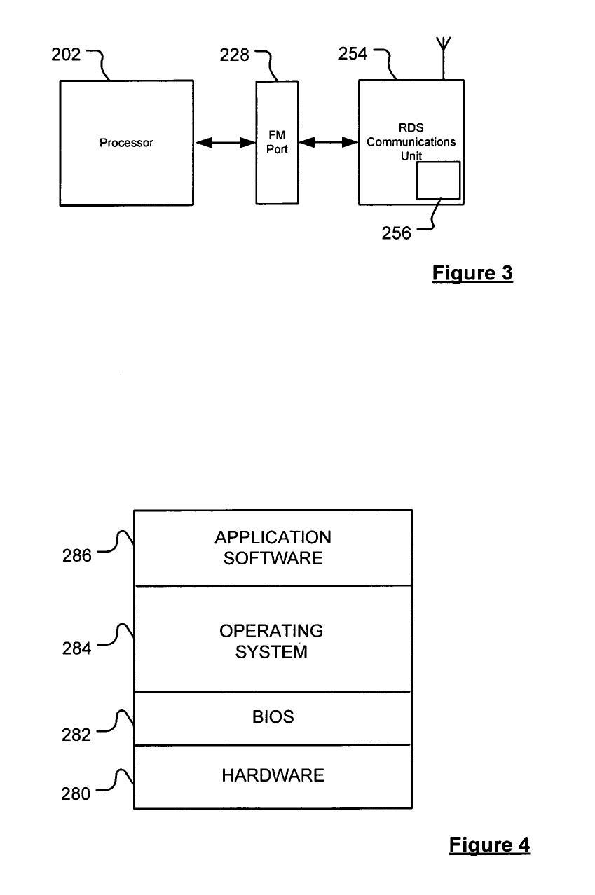

Turning to FIG. 3, the processor 202 is capable of communicating via the FM port 228 with a Radio Data System (RDS) communications unit 254. The RDS communications unit 254 comprises an RDS encoder 256 and communications circuitry to transmit both audio and RDS data in accordance with the RDS technical specification, for example as described in the IEC/CENELEC EN 62106 specification for RDS. As RDS communications units are know in the art, further detailed description of the structure of the RDS communications unit 254 will not be provided herein for the sake of clarity and conciseness of description.

Referring now to FIG. 4, the processor 202 and memory 214 cooperate to support a BIOS (Basic Input/Output System) 282 that functions as an interface between functional hardware components 280 of the navigation device 200 and the software executed by the device. The processor 202 then loads an operating system 284 from the memory 214, which provides an environment in which application software 286 (implementing some or all of the above described route planning and navigation functionality) can run. The application software 286 provides an operational environment including the GUI that supports core functions of the navigation device 200, for example map viewing, route planning, navigation functions and any other functions associated therewith. Map data is stored by the memory 214. Additionally, the memory 214 also stores country code data (not shown), details of which will be described later herein.

Referring to FIG. 5, in the following examples, the navigation device 200 is to be used in a vehicle, for example an automobile 300 having an in-vehicle entertainment system, for example an audio entertainment system, such as an FM radio 302 or tuner having an FM receiver (not shown) therein and a display 302. The FM radio 303 is coupled to a loudspeaker system 304. However, the skilled person should appreciate that the navigation device 200 can be deployed in other environments where an RDS capable FM receiver exists that is coupled to one or more loudspeakers, the use of the loudspeakers being desired for audio output of audio signals originating from another device or apparatus. To facilitate use thereof, the portable or handheld navigation device 200 of FIG. 2 can be connected or “docked” in a known manner to the automobile 300, or any other suitable vehicle, for example a bicycle, a motorbike, a car or a boat. The navigation device 200 is then removable from the docked location for portable or handheld navigation use. In this respect (FIG. 6), the navigation device 200 may be a unit that includes the integrated input and display device 320 and the other components of FIG. 2 (including, but not limited to, the internal GPS receiver 224, the microprocessor 202, a power supply (not shown), memory systems 214, etc.).

The navigation device 200 may sit on an arm 322, which itself may be secured to a vehicle dashboard/window/etc. using a suction cup 324. This arm 322 is one example of a docking station to which the navigation device 200 can be docked. The navigation device 200 can be docked or otherwise connected to the arm 322 of the docking station by snap connecting the navigation device 200 to the arm 322 for example. The navigation device 200 may then be rotatable on the arm 322. To release the connection between the navigation device 200 and the docking station, a button (not shown) on the navigation device 200 may be pressed, for example. Other equally suitable arrangements for coupling and decoupling the navigation device 200 to a docking station are well known to persons of ordinary skill in the art.

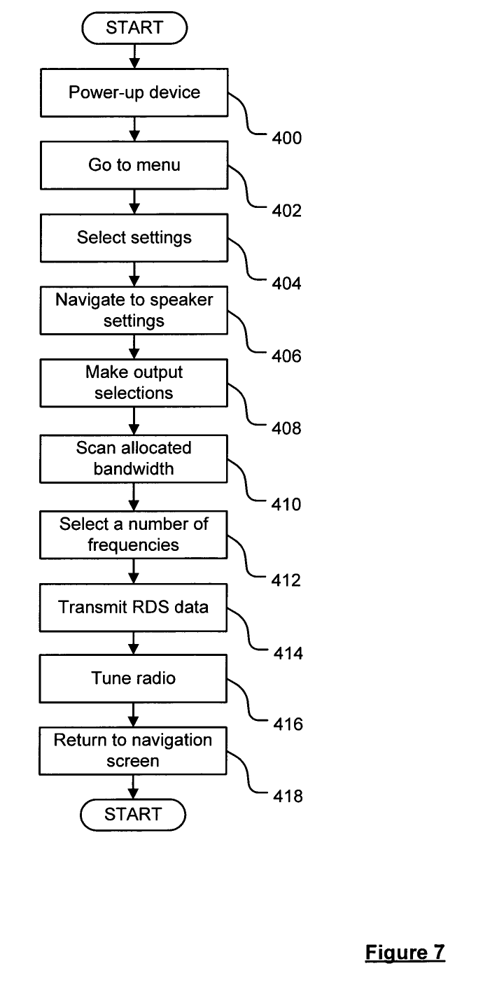

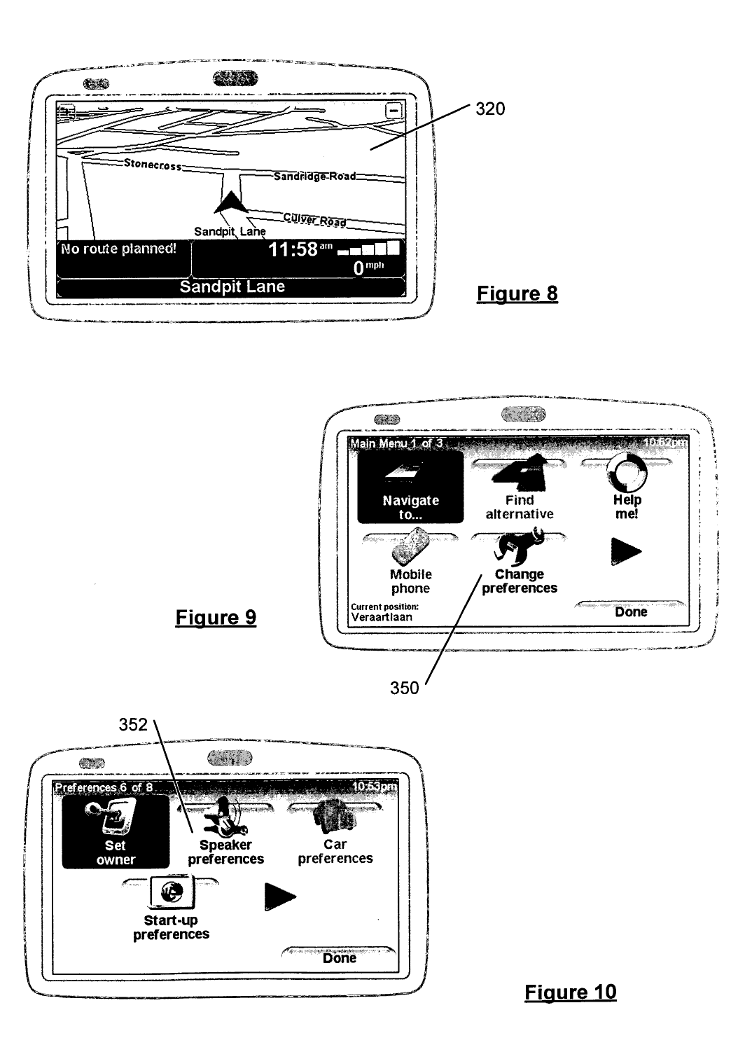

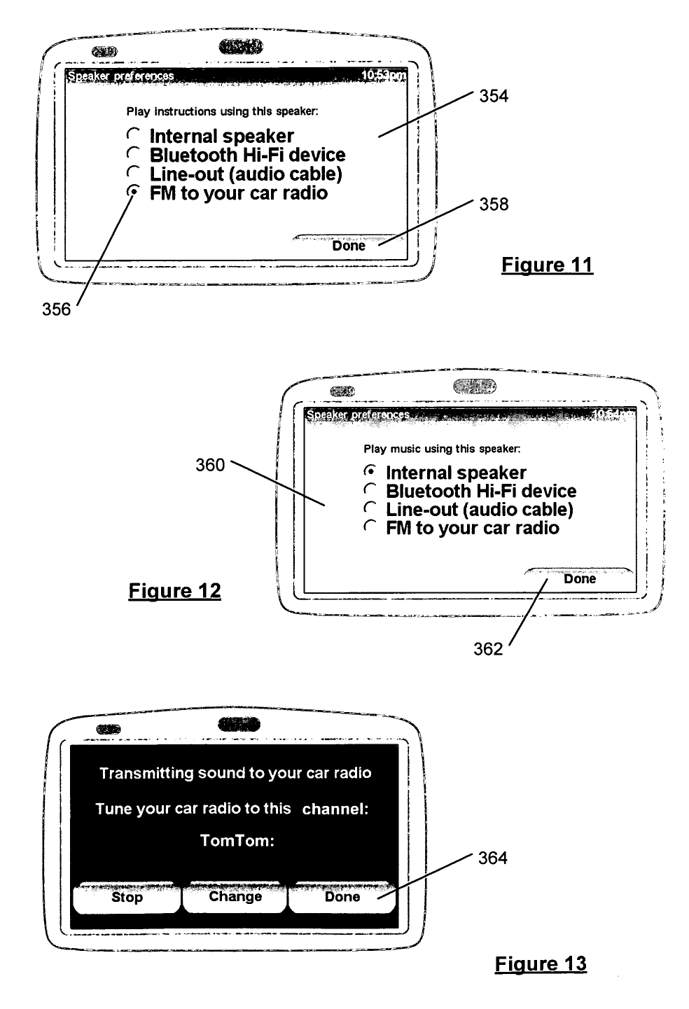

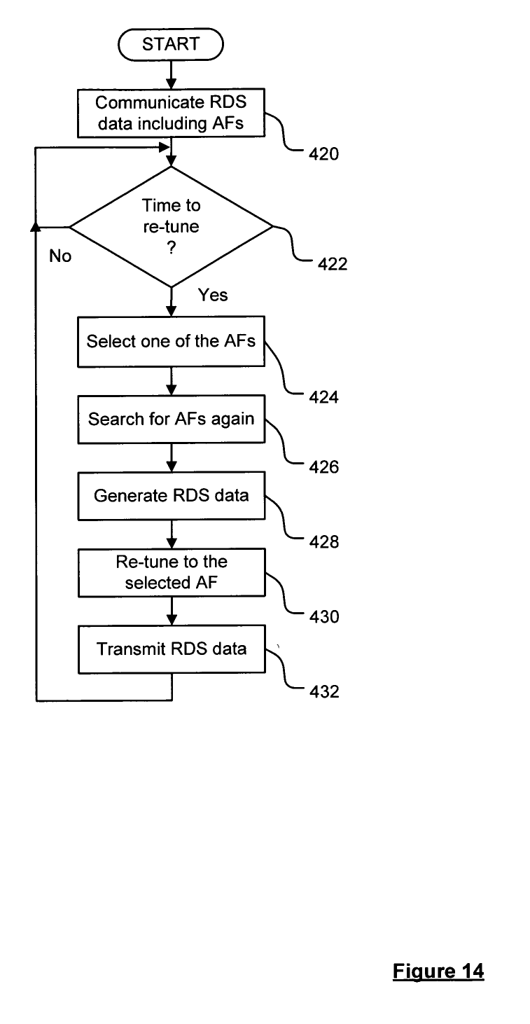

In operation (FIG. 7), a user of the navigation device 200 wishes to drive to an office approximately 6 km from home using traffic avoidance functionality of the navigation device 200. After entering the automobile 300, the user powers-up (Step 400) the navigation device 200 (FIG. 8) and touches the touchscreen display 320 in order to access a menu structure provided by the GUI (Step 402). The user then selects (Step 404) the “Change preferences” menu option 350 (FIG. 9) and then negotiates the menu structure (Step 406) to reach a “Speaker preferences” menu option 352 (FIG. 10). Upon selecting the speaker preferences menu option 352, the GUI displays a first screen of speaker preference options 354 (FIG. 11) in respect of audible instructions provided by the navigation device 200. In this example, the user wishes the audible instructions to be played through the loudspeaker 304 in the automobile 300 and so selects (Step 408) an “FM to your car radio” option 356. The user then presses a “Done” soft button 358 to indicate that a final selection has been made and the GUI then displays a second screen of speaker preference options 360 (FIG. 12) in respect of music provided by or via the navigation device 200. In this example, it is possible to couple an electronic music player to the navigation device 200 in order to permit play of music through the navigation device 200, either through an internal speaker of the navigation device 200 or another external output device. For the sake of simplicity, this example assumes that no music player or other source of audio signals is coupled to the navigation device 200. However, the skilled person will appreciate that the principles described herein in relation to play of the navigation instructions through the loudspeakers 304 of the FM radio 302 are applicable to the option of use of the loudspeakers 304 in relation to other sources of audio signals. As a consequence of the above assumption, the user does not modify any options presented on the second screen of speaker preference options 360 in respect of music and simply presses another “Done” soft key 362.

The processor 202 in cooperation with the RDS communications unit 254 then scans (Step 410) a frequency band allocated for FM radio broadcast and identifies a plurality of available frequencies that are not occupied by other broadcasters and so can serve as a frequency to which the FM receiver can be tuned and a respective plurality of Alternative Frequencies (AFs). The processor 202 then selects (Step 412) a number of AFs from the plurality of AFs, the selected number of the AFs being stored in the memory 214. In this respect, it is known that a typically memory allocation made in respect of FM receivers is for storage of 25 AFs, which is consistent with the number of Alternative Frequencies that can be transmitted relating to the PI code using the type 0A message set out in the RDS technical specification. In order to avoid filling the memories of receivers, for example of the FM radio 302, the processor 202 caps the number of AFs selected to a predetermined maximum quantity of AFs that is less than the capacity of the typical memory capacity of receivers, for example by a margin of entries. In this example, the number of AFs selected is therefore less than 25, for example about 20. However, a smaller number of AFs can be selected, for example less than about 15 AFs, such as less than about 10 AFs. The number of AFs selected can be even fewer, for example less than about 5 AFs. Once the number of AFs has been selected from the plurality of AFs identified, the RDS communications unit 254 of the navigation device 200 tunes to the tuned frequency selected above and transmits (Step 414) first RDS data, for example type 0A groups, comprising a list of the selected AFs. Of course, the RDS communications unit 254 transmits other RDS data, for example a Programme Identification code and the Programme Service name (“TomTom”) associated with the tuned frequency. In this example, the Programme Identification code can be generated in accordance with the technique proposed by the RDS Forum for portable electronic apparatus known to those skilled in the art. Furthermore, the list of AFs is usually communicated over a series of messages or groups.

The GUI then passes to an instruction screen (FIG. 13), which instructs the user to tune the FM radio 302, in present example located in the automobile 300, to a channel identified by the Programme Service name “TomTom”. The user therefore sets the FM radio 302 to scan for stations (Step 416), RDS capabilities of the FM radio 302 enabling the name of each station detected to be presented by the display 303 of the FM radio 302.

The scanning procedure therefore eventually results in the FM radio 302 being tuned to the TomTom “channel”, the frequency associated with the TomTom channel being the tuned frequency. The first RDS data, for example the type 0A group comprising the list of selected AFs, is also received in respect of the tuned frequency. As part of the tuning process, the FM radio 302 stores the selected AFs received in a respective space allocated in the memory (not shown) thereof reserved for a channel being received. As the number of AFs has been capped in quantity, the number of AFs stored in the memory of the FM radio 302 does not occupy the whole capacity of the memory of the FM radio 302 allocated for a single channel. Consequently, when further AFs are added to the memory of the FM radio 302 during use of the FM radio 302 as a result of the navigation device 200 communicating AFs during the course of the journey, the occurrence of NREs, and hence the storing of erroneous AFs in the memory of the FM radio 302, does not result in or minimises correct AFs being purged from the memory of the FM radio 302 in preference of the erroneous AFs.

Once the FM radio 302 has acquired the “TomTom” broadcast, the user presses a further “Done” soft key 364 (FIG. 13) and the GUI responds by returning (Step 418) to a map display screen (FIG. 8).

Whilst, in the above example, the RDS communications unit 254 has searched for the plurality of available frequencies, for example all available frequencies, the skilled person should appreciate that only the number of AFs required can be identified for communication during the scanning process carried out by the navigation device 200 without identifying all available frequencies or more than are required. For example, the processor 202 can simply select the first AFs encountered whilst scanning and stop once sufficient AFs have been found to comply with the cap implemented.

As an additional or alternative measure to the technique described above, to prevent problems associated with the storage of erroneous AFs by the FM radio 302, the navigation device 200 functions as follows.

Once the FM radio 302 has been tuned to the TomTom channel, audio signals transmitted by the navigation device 200, for example navigation instructions, are reproduced by the loudspeakers 304 once, for example, a route has been set or an instruction provided to avoid traffic by a user of the navigation device 200.

As mentioned above, during use of the navigation device 200 and the FM radio 302 such that the navigation device 200 is communicating RDS data to the FM radio 302 via FM broadcast, the allocated memory space of the FM radio 302 in respect of the “TomTom” channel received by the FM radio 302 can fill with erroneous AFs as a result of the occurrence of NREs. This problem is particularly acute due to the relatively short distance of the journey resulting in a low probability of the FM radio 302 needing to re-tune on account of poor signal strength in respect of the tuned frequency during the course of the journey.

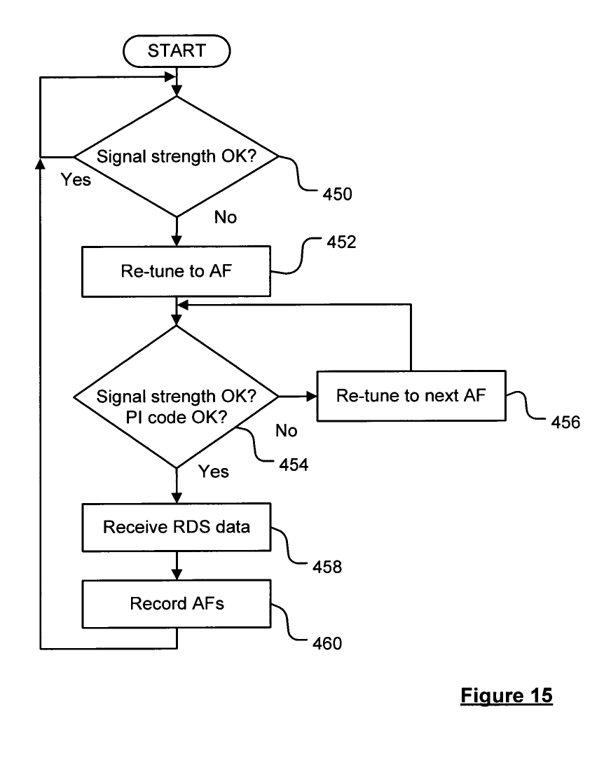

Turning to FIG. 14, the navigation device 200, via the RDS communications unit 254, transmits (Step 420) RDS data including the number of AFs as mentioned above, the AFs being stored in the allocated memory space of the FM radio 302. Additionally, the processor 202 operates an update trigger scheme that is used to determine when it is necessary to act so as to trigger the FM radio 302 to refresh the memory thereof in respect of the Programme Identification code associated with the navigation device 200. In this example, the processor 200 implements a periodic update trigger scheme by acting on a periodic basis, for example every hour, every two hours, every day, every week and/or every month. In this example, the periodic update trigger scheme is arranged to trigger the FM radio 302 to refresh the memory thereof in respect of the Programme Identification code every day. Consequently, the processor 202 monitors a clock (not shown) maintained by the navigation device 200 in order to determine (Step 422) when a day has elapsed and so it is necessary to re-tune the RDS communication unit 254 to another frequency. In this respect, once a day has elapsed, the another frequency is selected (Step 424) from the number of AFs previously selected. Typically, the another frequency is a first AF in the list of AFs that is the number of AFs. Hence, it can be seen that the act of re-tuning by the RDS communications unit 254 is supplemental to any need to re-tune as a result of inadequate signal strength caused by, for example, interference.

Alternatively, instead of a cyclic or periodic scheme, a randomised scheme can be employed in which the time interval between triggering is a random amount of time. The navigation device 200 can be further enhanced by enabling detection of start-up of the RDS communications unit 254 following a period of non-use thereof and using the detection of the start-up as the trigger.

Once the FM transmitter has selected the another frequency, the RDS communications unit 254 then proceeds to perform a search (Step 426) for AFs followed by generation (Step 428) of RDS data comprising the new AFs. The new AFs found are stored in the memory 214 in place of the previously selected number of AFs. The RDS communications unit 254 then re-tunes (Step 430) to the another frequency and transmits (Step 432) the second RDS data, for example the type 0A groups identifying the new AFs.

At the FM radio 302, the receiver thereof monitors (Step 450) receive signal strength. Whilst the receive signal strength associated with the tuned frequency is sufficiently strong, the receiver of the FM radio 302 continues to receive on the tuned frequency in accordance with the RDS technical specification. However, when the receive signal strength falls below a threshold value, the FM radio 302 accesses the memory thereof to identify a first AF from the number of AFs stored in the memory of the FM radio 302 and re-tunes (Step 452) to the first AF selected. The FM radio 302 then monitors (Step 454) the receive signal strength associated with the first AF retrieved from the memory of the FM radio 302. If the signal strength associated with the first AF is inadequate, the FM radio 302 accesses the memory thereof again to identify a second AF from the number of AFs stored in the memory of the FM radio 302 and re-tunes (Step 456) to the second AF selected. The above procedure (Steps 454 and 456) is repeated until another AF has been found that has an adequate signal strength associated therewith. Of course, a possible cause of poor measured signal strength is that the AF used is erroneous having been recorded in the memory of the FM radio 302 as a result of an NRE. In such circumstances, the FM radio 302 is unable to obtain the Programme Identification code associated with the TomTom channel, in which case even if the signal strength is sufficient, the FM receiver will still re-tune to the next AF in the AF list stored by the FM radio 302.

Once the FM receiver 302 has tuned to an AF having adequate signal strength associated therewith and a correct Programme Identification code, the FM radio 302 proceeds to receive the second RDS data transmitted by the navigation device 200 as described above. In particular, the FM radio 302 receives the type 0A group identifying the new AFs and records the new AFs in place of the number of AFs currently stored in the memory of the FM radio 302. Hence, the number of AFs previously stored in the memory of the FM radio 302, and possibly including erroneous AFs attributable to NREs, are replaced by the new AFs received from the navigation device 200 on the another frequency and thus the memory of the FM radio 302 is purged.

It should be understood that the FM radio 302 and the navigation device 200 constitute, in the above examples, a communication system.

Whilst the above examples have been predominantly described in the context the RDS, the skilled person will appreciate the above embodiments can be employed in relation to the different technical specification implemented in North America, for example in the United States of America, known as the Radio Broadcast Data System (RBDS). Hence, for the avoidance of doubt, references herein to the RDS should be construed to embrace the RBDS as well.

It should be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

For example, it should be noted that although the RDS communications unit 254 described herein is internal to the navigation device 200, the FM port 228 can be provided for coupling an external RDS communications unit to the navigation device 200 or any other suitable portable electronic apparatus.

As another example, whilst embodiments described in the foregoing detailed description refer to GPS, it should be noted that the navigation device may utilise any kind of position sensing technology as an alternative to (or indeed in addition to) the GPS. For example the navigation device may utilise other global navigation satellite systems (GNSS) such as the proposed European Galileo system when available. Equally, it is not limited to satellite based but could readily function using ground based beacons or any other kind of system that enables the device to determine its geographic location, for example the long range navigation (LORAN)-C system.

By way of further example, it should be appreciated that although the above embodiments have been described in the context of a navigation device, the techniques described herein are not only applicable to navigation devices, but also to any other electronic communications apparatus in respect of which it is desirable to transmit RDS or RDBS data on an FM channel for receipt by an FM receiver, for example mobile telephones or media players, such as music players, in particular but not exclusively MP3 players or accessories therefor.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

It will also be well understood by persons of ordinary skill in the art that whilst the preferred embodiment implements certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

Lastly, it should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

1. A portable electronic communications apparatus, comprising:
a processing resource operably coupled to a Radio Data System communications unit, the processing resource being arranged to identify, when in use, a number of available frequencies capable of serving as a number of Alternative Frequencies, respectively, and to communicate on a tuned frequency first Radio Data System data identifying the number of Alternative Frequencies; and
a data store operably coupled to the processing resource; wherein the Radio Data System communications unit is arranged to re-tune, when in use, from the tuned frequency to another frequency of the number of available frequencies and to communicate on the another frequency second Radio Data System data, the re-tuning being supplemental to any re-tuning initiated as a result of inadequate signal strength associated with the tuned frequency.

2. An apparatus as claimed in claim 1, wherein the data store is arranged to store the number of Alternative Frequencies.

3. An apparatus as claimed in claim 2, wherein the processing resource is arranged to identify another number of available frequencies capable of serving as another number of Alternative Frequencies, respectively, and to communicate on the another frequency the second Radio Data System data, the second Radio Data System data identifying the another number of Alternative Frequencies.

4. An apparatus as claimed in claim 3, wherein the data store is arranged to store the another number of Alternative Frequencies in place of the number of Alternative Frequencies.

5. An apparatus as claimed in claim 1, wherein the Radio Data System communications unit is arranged to re-tune to the another frequency in accordance with a periodic update trigger scheme.

6. An apparatus as claimed in claim 1, wherein the Radio Data System communications unit is arranged to re-tune to the another frequency in response to start-up of the Radio Data System communications unit.

7. An apparatus as claimed in claim 1, wherein the Radio Data System communications unit is arranged to re-tune to the another frequency in accordance with a random update trigger scheme.

8. An apparatus as claimed in claim 1, wherein the processing resource is arranged to select the number of Alternative Frequencies from a plurality of available frequencies capable of serving as a plurality of Alternative Frequencies, respectively, so as to be less than in quantity a total number of the plurality of Alternative Frequencies, the number of Alternative Frequencies communicated constituting a cap in quantity of Alternative Frequencies with respect to the total number of the plurality of available frequencies.

9. An apparatus as claimed in claim 8, wherein the processing resource is arranged to identify the plurality of Alternative Frequencies prior to selection therefrom.

10. A portable navigation device comprising the portable electronic communications apparatus as claimed in claim 1.

11. A method of purging error data from a memory of a receiver, the method comprising:
a portable electronic communications apparatus identifying a number of available frequencies capable of serving as a number of Alternative Frequencies, respectively;
communicating on a tuned frequency first Radio Data System data identifying the number of Alternative Frequencies;
re-tuning from the tuned frequency to another frequency of the number of available frequencies, the re-tuning being supplemental to any re-tuning initiated as a result of inadequate signal strength associated with the tuned frequency; and
communicating on the another frequency second Radio Data System data.

12. A portable electronic communications apparatus, comprising:
a processing resource operably coupled to a Radio Data System communications unit, the processing resource being arranged to identify, when in use, a number of available frequencies capable of serving as a number of Alternative Frequencies, respectively, and to communicate on a tuned frequency first Radio Data System data identifying the number of Alternative Frequencies; and
a data store operably coupled to the processing resource; wherein the processing resource is arranged to select, when in use, the number of Alternative Frequencies from a plurality of available frequencies capable of serving as a plurality of Alternative Frequencies, respectively, so as to be less than in quantity a total number of the plurality of Alternative Frequencies, the number of Alternative Frequencies communicated constituting a cap in quantity of Alternative Frequencies with respect to the total number of the plurality of available frequencies.

13. A communications system, comprising:
a portable electronic communications apparatus as claimed in claim 12; and
a receiver having a memory capacity capable of storing a maximum number of Alternative Frequencies; wherein
the processing resource is arranged to implement the cap as less than the maximum number of Alternative frequencies.

14. A system as claimed in claim 13, wherein the cap is less than the maximum number of Alternative frequencies by a predetermined margin.

15. A method of reducing a re-tuning delay caused by error data in a memory of a receiver, the method comprising:
a portable electronic communications apparatus identifying a number of available frequencies capable of serving as a number of Alternative Frequencies, respectively;
selecting the number of Alternative Frequencies from a plurality of available frequencies capable of serving as a plurality of Alternative Frequencies, respectively, so as to be less than in quantity a total number of the plurality of Alternative Frequencies; and
communicating on a tuned frequency first Radio Data System data identifying the number of Alternative Frequencies, the number of Alternative Frequencies communicated constituting a cap in quantity of Alternative Frequencies with respect to the total number of the plurality of available frequencies.

16. A method as claimed in claim 15, further comprising:
identifying the plurality of Alternative Frequencies prior to selection therefrom.

17. A computer program element comprising
computer program code to, when executed computer execute the method as claimed in claim 11.

18. A computer program element as claimed in claim 17, embodied on a non-transitory computer readable medium.
